(19) United States
(12) Patent Application Publication
(10) Pub. No.: US 2014/0010534 A1
(43) Pub. Date: Jan. 9, 2014

(54) Optical Line Terminal and Operation of Optical Network

(71) Applicants: Asia Optical International Ltd., Tortola (GB); Sintai Optical (Shenzhen) Co., Ltd., Shenzhen City (CN)

(72) Inventors: Chia-Tse Sun, Taichung (TW); Chia-Jen Lee, Taichung (TW)

(21) Appl. No.: 13/917,719

(22) Filed: Jun. 14, 2013

(30) Foreign Application Priority Data
Jul. 4, 2012 (TW) 101123951

(51) Int. Cl. H04B 10/27

(52) U.S. Cl. CPC H04B 10/27
USPC 398/45

(57) ABSTRACT

An optical line terminal and operation of optical network are provided. A light signal of the optical network unit is uploaded to an optical line terminal via a first channel. The light signal is processed by wave filtering, conversion, amplification and sampling so as to obtain a sampling signal. The light signal is uploaded to the optical line terminal via a second channel when all sampling values in the sampling signal are less than a threshold value.

### BACKGROUND OF THE INVENTION

1. Field of the Invention

The invention relates to an optical line terminal and operation of optical network.

2. Description of the Related Art

FIG. 1A is a schematic view of a conventional optical fiber network. In FIG. 1A, the conventional optical fiber network includes a plurality of optical network units (ONUs) (or referred to client sides) 31, 32 and 33 that are connected to an optical line terminal (OLT) (or referred to central office) 10 via a splitter 20. The optical network units 31, 32 and 33 are utilized to upload data to the optical line terminal 10 by means of time division multiple access (TDMA). When the data is uploaded by the optical network units 31, 32 and 33, each of the optical network units 31, 32 and 33 is only allocated to a time slot, and the data packets are transmitted in the allocated time slot.

In actual applications, it is liable to cause functional interruption of data transmission of the optical fiber network when a single optical fiber thereof is damaged, kinked (bent) or other failure factors. In view of this, an optical fiber line is configured with at least two optical fibers, in which one optical fiber is served as a main channel 41 and the other optical fiber is served as an alternate channel 42. Once the function of the main channel 41 is failed, the alternate channel 42 is switched to serve as the light beam transmission path. Specifically speaking, an average light power in an allocated time slot is calculated by the optical line terminal 10. The main channel 41 is judged as in an invalid state when the average light power in the allocated time slot is less than a threshold value (e.g., −30 dBm), and the alternate channel is therefore switched to serve as the light beam transmission path, thereby keeping signal transmission to be normally operated.

FIG. 1B illustrates the conventional optical fiber network progressing signal transmission under a burst mode. In FIG. 1B, in view of a very low period of time capable of presenting the light signal, if only a minority of clients (e.g., the optical network units 31) does use the optical fiber network, i.e., the majority of clients (e.g., the optical network units 32 and 33) do not use the optical fiber network, the value of a received average light power is very low (less than the threshold value), resulting in error events such as the optical line terminal 10 misjudging the main channel 41 as in an invalid state to cause the alternate channel 42 to be switched for serving as the light beam transmission path and to inform the worker of checking and maintaining the main channel 41.

### BRIEF SUMMARY OF THE INVENTION

In order to solve the issues above, the invention provides an optical line terminal The optical line terminal includes a light-receiving unit and a signal processing unit. The light-receiving unit is utilized to receive a light signal via a first channel and to convert the light signal into a current signal. The signal processing unit is utilized to process the current signal to obtain a sampling signal, in which the signal processing unit outputs a switching signal for switching the first channel to a second channel for the light-receiving unit to receive the light signal when all sampling values in the sampling signal are less than a threshold value.

In one aspect of the invention, the signal processing unit outputs a confirming signal to enable the light-receiving unit to continue to receive the light signal via the first channel when any sampling value in the sampling signal is greater than the threshold value.

In one aspect of the invention, the signal processing unit includes a current-voltage converter, a signal amplifier, an analog-to-digital converter, and a judgment and calculation module, in which the current-voltage converter is utilized to convert the current signal into a voltage signal, the signal amplifier is utilized to amplify the voltage signal into an amplified signal, the analog-to-digital converter is utilized to convert the amplified signal into a digital signal that is sampled for obtaining the sampling signal, and the judgment and calculation module is utilized to judge the sampling signal so as to output the confirming signal or the switching signal.

In one aspect of the invention, the light-receiving unit includes a filter and an optical detector, in which the filter is utilized to filter the light signal to obtain a processed light signal, and the optical detector is utilized to convert the processed light signal into the current signal.

The invention also provides operation of optical network. The operation of optical network includes the steps of uploading a light signal of an optical network unit to an optical line terminal via a first channel; processing the light signal by wave filtering, conversion, amplification and sampling so as to obtain a sampling signal; and switching the first channel to a second channel for uploading the light signal to the optical line terminal when all sampling values in the sampling signal are less than a threshold value.

In one aspect of the invention, the operation of optical network further includes a step of continuing to transmit the light signal via the first channel when any sampling value in the sampling signal is greater than the threshold value.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1A is a schematic view of a conventional optical fiber network;

FIG. 1B illustrates the conventional optical fiber network progressing signal transmission under a burst mode;

FIG. 2 is a schematic view of an optical fiber network of the invention;

FIG. 3 is a block diagram of an optical line terminal of the invention;

FIG. 4 illustrates a waveform of a processed light signal S₂ under a burst mode of the invention;

FIG. 5 illustrates a waveform of a current signal S₃ under a burst mode of the invention;

FIG. 6 illustrates a waveform of a voltage signal S₄ under a burst mode of the invention;

FIG. 7 illustrates a waveform of a sampling signal S₆ under a burst mode of the invention;

FIG. 8 illustrates a waveform of a sampling signal S₆ of in-use channel invalidity of the invention; and

FIG. 9 is a flow chart of operation of optical network of the invention.

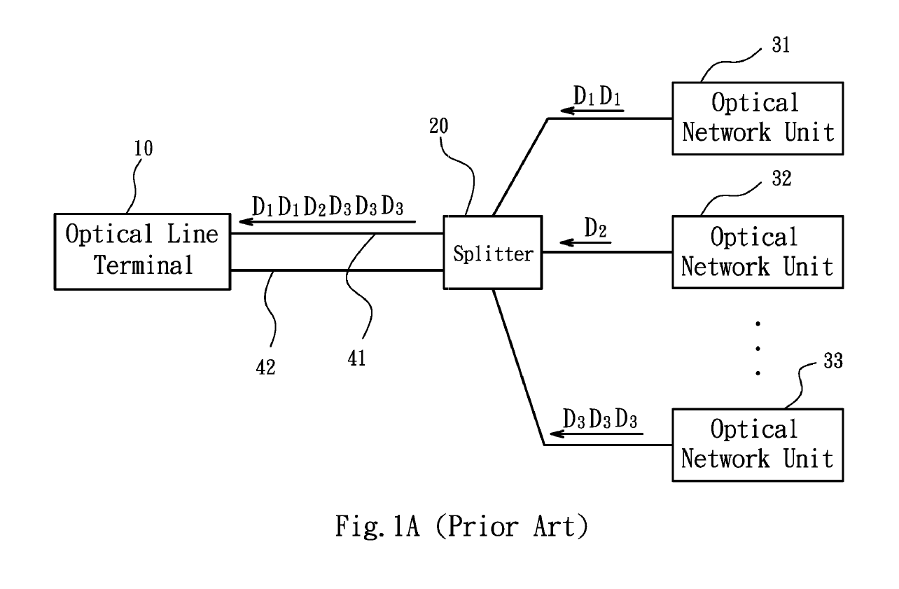

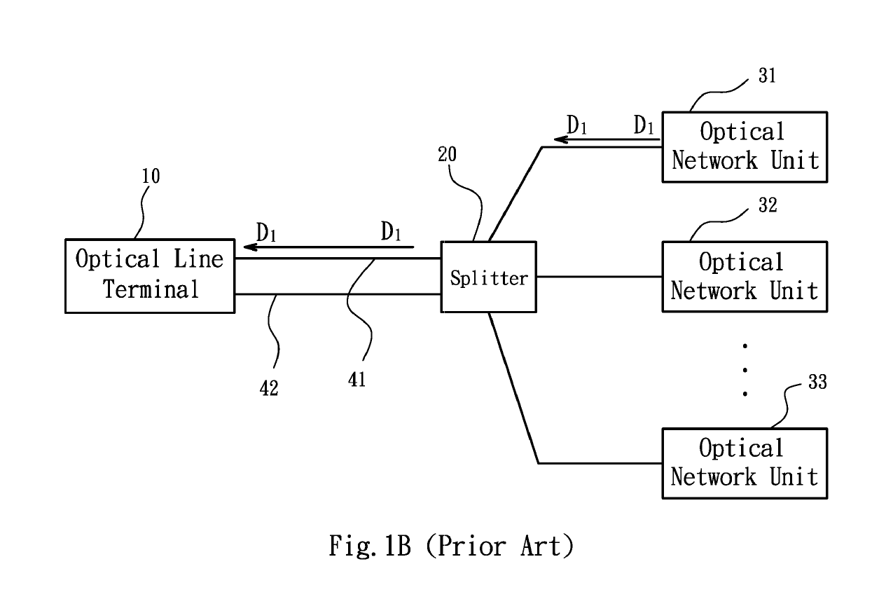

### DETAILED DESCRIPTION OF THE INVENTION

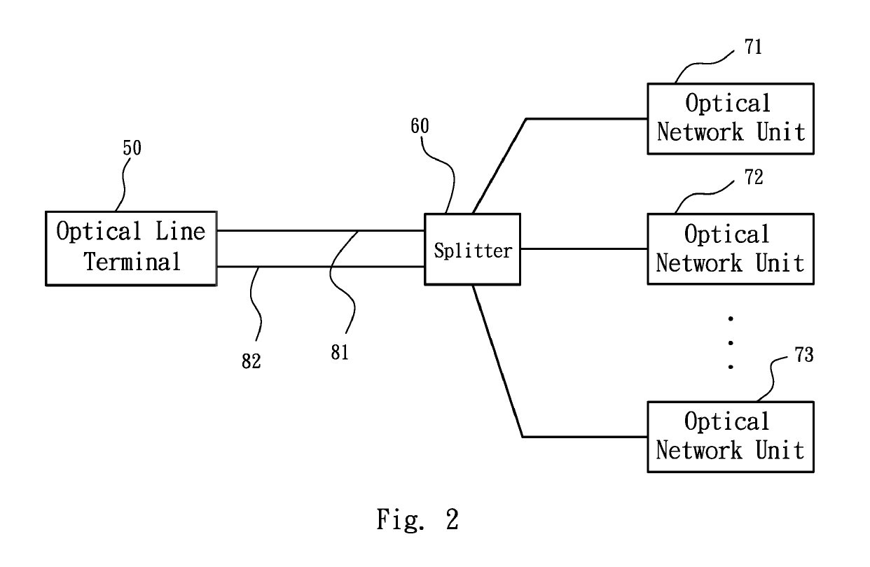

FIG. 2 is a schematic view of an optical fiber network of the invention. In FIG. 2, the optical fiber network of the invention comprises a plurality of optical network units (ONUs) (or referred to client sides) 71, 72 and 73 that are connected to an optical line terminal (OLT) (or referred to central office) 50 via a splitter 60 and two (first and second) channels 81 and 82. The optical network units 71, 72 and 73 are utilized to upload data to the optical line terminal 50 via the first channel 81 (or the second channel 82) by means of time division multiple access (TDMA). In this embodiment, the first channel 81 is a main channel and the second channel 82 is an alternate channel. However, it is understood that the invention is not limited to this arrangement, the first channel 81 can be an alternate channel and the second channel 82 can be a main channel.

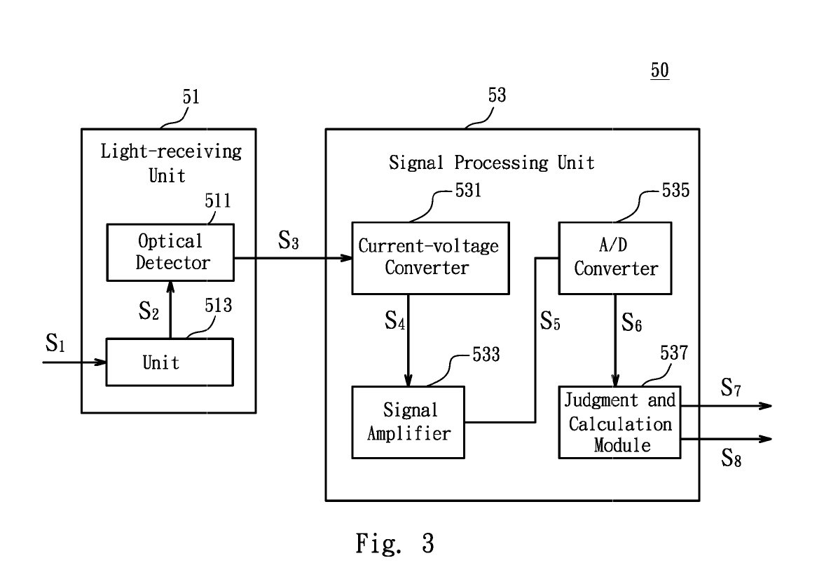

FIG. 3 is a block diagram of an optical line terminal 50 of the invention. In FIG. 3, the optical line terminal 50 of the invention comprises a light-receiving unit 51 and a signal processing unit 53, in which the light-receiving unit 51 is utilized to receive a light signal S₁ transmitted from the optical network units 71, 72 and 73 and to convert the light signal S₁ into a current signal S₃, and the signal processing unit 53 is utilized to perform operations such as conversion, amplification, judgment and calculation on the current signal S₃ so as to judge whether the first channel 81 is valid or not. The related content is described in details as follow.

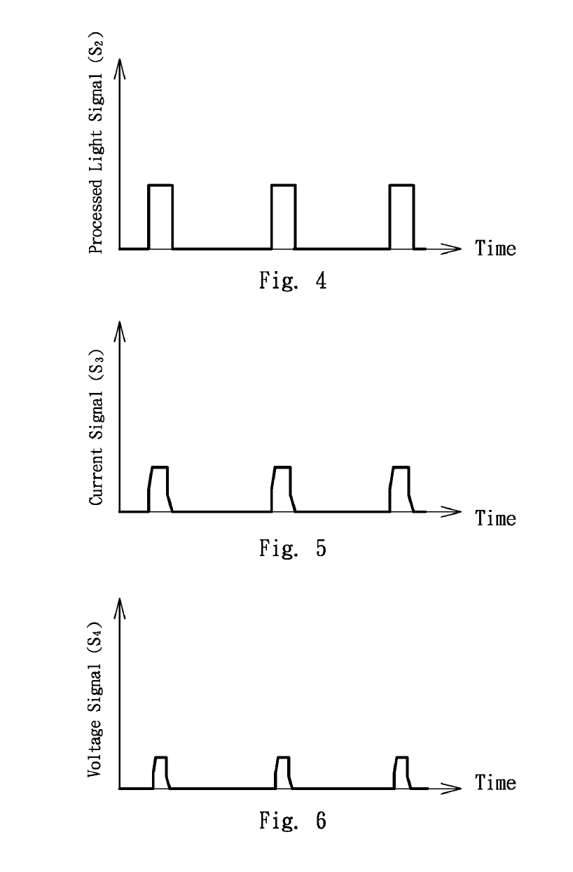

The light-receiving unit 51 comprises an optical detector 511 and a filter 513. The filter 513 is utilized to filter an unwanted part of the light signal to limitedly allow pass of a light beam with particular wavelength, thereby obtaining a processed light signal S₂. Referring also to FIG. 4, a waveform of a processed light signal S₂ under a burst mode of the invention is illustrated. The optical detector 511 is utilized to convert the processed light signal S₂ into the current signal S₃ (shown in FIG. 5) and to output the current signal S₃.

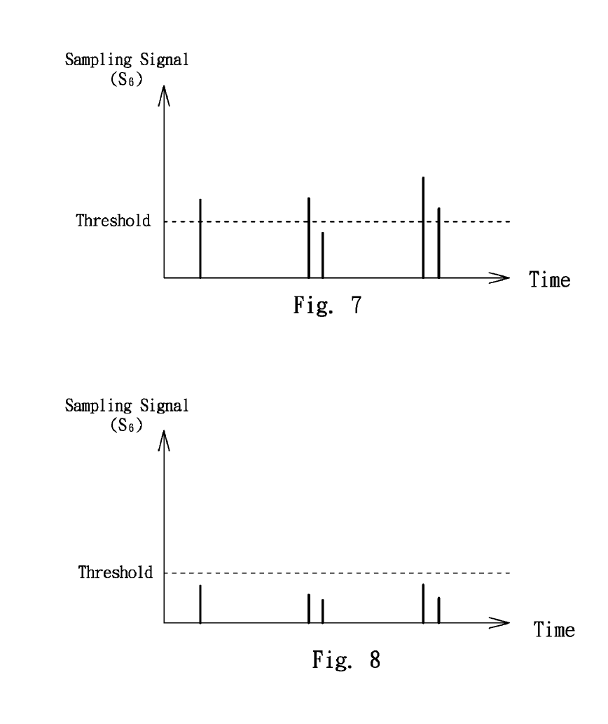

The signal processing unit 53 comprises a current-voltage converter 531, a signal amplifier 533, an analog-to-digital converter 535, and a judgment and calculation module 537. The current-voltage converter 531 is utilized to convert the current signal S₃ into a voltage signal S₄ (shown in FIG. 6). The signal amplifier 533 is utilized to amplify the voltage signal S₄ into an amplified signal S₅. The analog-to-digital converter 535 is utilized to convert the amplified signal S₅ into a digital signal that is sampled for obtaining the sampling signal S₆ (shown in FIG. 7). The judgment and calculation module 537 is utilized to judge the sampling signal S₆. In the judgment and calculation module 537, the first channel 81 is judged as in a valid state when any sampling value in the sampling signal is greater than a threshold value, and the confirming signal S₇ is therefore output to a host (not shown in FIGs.), thereby informing the host of the first channel 81 to be normally operated; the first channel 81 is judged as in an invalid state when all sampling values in the sampling signal are less than the threshold value (shown in FIG. 8), and a switching signal S₈ is therefore produced to switch to the second channel 82 as the light beam transmission path, thereby keeping signal transmission to be normally operated.

A further description is provided as follow. In a burst mode of very few clients using the optical fiber network, in view of a very low period of time capable of presenting the light signal as compared to an allocated time slot thereof, an incorrect judgment of the signal processing unit 53 is possibly occurred when adopting a value that is usually very low in the calculation of average light power and less than a threshold value. The invention assumes a sampling signal as a judgment basis rather than the calculation of average light power. As long as there have data to be uploaded by the client, the obtained sampling signal does contain a sampling value greater than the threshold value, so that the first channel 81 is normally operated, without an event such as incorrectly to switch to the second channel 82 as the light beam transmission path. If a normal light signal transmission is truly influenced by the damaged first channel 81, there has no exception in the invention that all sampling values in the sampling signal are less than the threshold value, and therefore the first channel 81 can be surely judged as in an invalid state.

It is possible to combine these disclosed components in the above-described embodiments, such as to integrate the current-voltage converter 531 and the signal amplifier 533 into the same chip, to integrate the analog-to-digital converter 535 and the judgment and calculation module 537 into the same chip, or to divide one or more from the units into individual units so as to perform the same function.

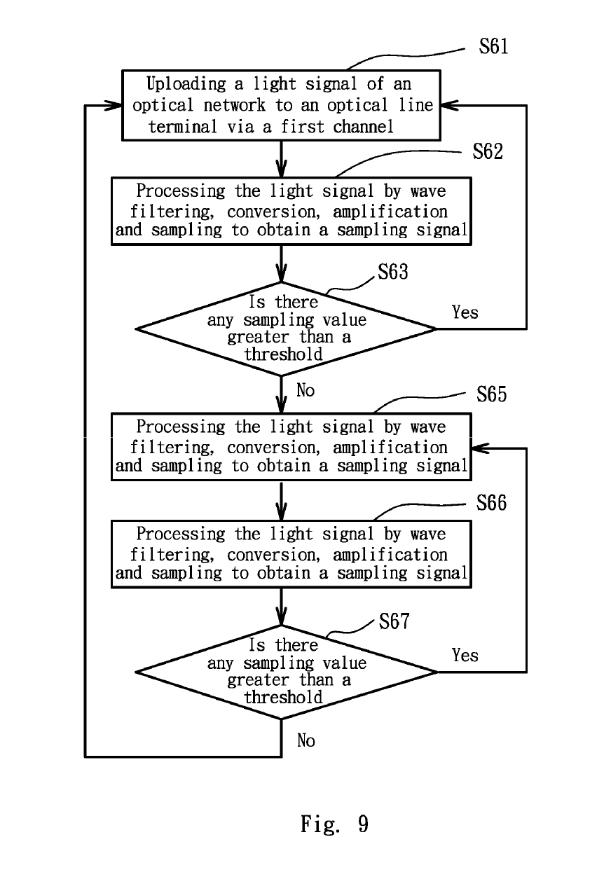

FIG. 9 is a flow chart of operation of optical network of the invention. In FIG. 9, the operation of optical network comprises the steps as follow.

In a step S61, a light signal of an optical network unit is uploaded to an optical line terminal 50 via a first channel.

In a step S62, the light signal is treated by processes of wave filtering, conversion, amplification and sampling so as to obtain a sampling signal.

In a step S63, judging whether any sampling value in the sampling signal is greater than a threshold value or not is provided. The first channel is judged as in a valid state if there has one sampling value in the sampling signal is greater than the threshold value, and then the procedure is returned to the step S61 to continue using the first channel to transmit data. The first channel is judged as in an invalid state if all sampling values in the sampling signal are less than the threshold value, and then a next step S65 is proceeded.

Because the judged first channel in the invalid state is incapable of transmitting data normally, in the step S65 the second channel is switched to serve as the light beam transmission path for transmitting data, allowing the worker to check and maintain the first channel.

In a step S66, the light signal transmitted from the second channel is treated by processes of wave filtering, conversion, amplification and sampling so as to obtain a sampling signal.

In a step S67, judging whether any sampling value in the sampling signal is greater than a threshold value or not is provided. The second channel is judged as in a valid state if there has one sampling value in the sampling signal is greater than the threshold value, and then the procedure is returned to the step S65 to continue using the second channel to transmit data. The second channel is judged as in an invalid state if all sampling values in the sampling signal are less than the threshold value, and then the procedure is returned to the step S61. As mentioned above, the second channel is switched to serve as the light beam transmission path for transmitting data when the first channel is judged as in the invalid state, and then the worker is sent to maintain the first channel. Therefore, if the second channel is in the invalid state after a period of time, the maintained first channel can be switched to serve as the light beam transmission path for transmitting data.

In conclusion, the invention can utilize comparison of the sampling signal and the threshold value to correctly judge whether the first channel or the second channel in use is normally operated or not. If either the first channel or the second channel is abnormally operated, the problem channel is immediately replaced by a normal channel, thereby ensuring data to be normally transmitted.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An optical line terminal, comprising:
a light-receiving unit utilized to receive a light signal via a first channel and to convert the light signal into a current signal; and
a signal processing unit utilized to process the current signal to obtain a sampling signal, in which the signal processing unit outputs a switching signal for switching the first channel to a second channel for the light-receiving unit to receive the light signal when all sampling values in the sampling signal are less than a threshold value.

2. The optical line terminal as claimed in claim 1, wherein the signal processing unit outputs a confirming signal to enable the light-receiving unit to continue to receive the light signal via the first channel when any sampling value in the sampling signal is greater than the threshold value.

3. The optical line terminal as claimed in claim 2, wherein the signal processing unit comprises a current-voltage converter, in which the current-voltage converter is utilized to convert the current signal into a voltage signal.

4. The optical line terminal as claimed in claim 2, wherein the signal processing unit comprises a signal amplifier, in which the signal amplifier is utilized to amplify the voltage signal into an amplified signal,

5. The optical line terminal as claimed in claim 2, wherein the signal processing unit comprises an analog-to-digital converter, in which the analog-to-digital converter is utilized to convert the amplified signal into a digital signal that is sampled for obtaining the sampling signal.

6. The optical line terminal as claimed in claim 2, wherein the signal processing unit comprises a judgment and calculation module, in which the judgment and calculation module is utilized to judge the sampling signal so as to output the confirming signal or the switching signal.

7. The optical line terminal as claimed in claim 1, wherein the light-receiving unit comprises a filter and an optical detector, in which the filter is utilized to filter the light signal to obtain a processed light signal, and the optical detector is utilized to convert the processed light signal into the current signal.

8. Operation of optical network, comprising:
uploading a light signal of an optical network unit to an optical line terminal via a first channel;
processing the light signal by wave filtering, conversion, amplification and sampling so as to obtain a sampling signal; and
switching the first channel to a second channel for uploading the light signal to the optical line terminal when all sampling values in the sampling signal are less than a threshold value.

9. The operation of optical network as claimed in claim 8 further comprising a step of continuing to transmit the light signal via the first channel when any sampling value in the sampling signal is greater than the threshold value.
